(19) United States
(12) Patent Application Publication
(10) Pub. No.: US 2020/0116545 A1
(43) Pub. Date: Apr. 16, 2020

(54) MONITORING THE CONDITION OF A VIBRONIC SENSOR

(71) Applicant: Endress+Hauser SE+Co. KG, Maulburg (DE)

(72) Inventor: Thomas Vogt, Maulburg (DE)

(21) Appl. No.: 16/482,093

(22) PCT Filed: Jan. 15, 2018
(86) PCT No.: PCT/EP2018/050828

§ 371 Date: Jul. 30, 2019

(30) Foreign Application Priority Data
Feb. 9, 2017 (DE) 10 2017 102 550.2

(51) Int. Cl. G01F 25/00; G01F 23/296; G01N 9/00

(52) U.S. Cl. CPC G01F 25/0061; G01N 9/002; G01F 23/2967

(57) ABSTRACT

The present invention relates to a method for monitoring a condition of a vibronic sensor, which serves for determining and/or monitoring at least one process variable of a medium in a container and which includes at least one sensor unit having a mechanically oscillatable unit. The method includes steps of ascertaining a measured value for at least one physical and/or chemical variable (f, f₀) characteristic for the vibronic sensor, while the sensor is located at/in its location of use, comparing the measured value of the physical and/or chemical variable (f, f₀) with a reference value (f_{ref}, f_{0,ref}) for the variable, and ascertaining a condition indicator from the comparison.

The invention relates to a method for monitoring the condition of a vibronic sensor, which serves for determining and/or monitoring at least one, especially physical or chemical, process variable of a medium in a container. The vibronic sensor includes a sensor unit having a mechanically oscillatable unit.

The process variable to be monitored can be, for example, the fill level of a medium in a container or the flow of a medium through a pipe or tube, however, also the density, the viscosity, the pH value, the pressure, the conductivity or the temperature. Also, optical sensors, such as turbidity- or absorption sensors, are known. The different underpinning measuring principles as well as the fundamental constructions and/or arrangements are known from a large number of publications. Corresponding field devices are manufactured and sold by the applicant in great variety.

Vibronic sensors find multiple application in process and/or automation technology. In the case of fill-level measuring devices, such have at least one mechanically oscillatable unit, such as, for example, an oscillatory fork, a single tine or a membrane. Such is excited to execute mechanical oscillations during operation by means of a driving/receiving unit, frequently in the form of an electromechanical transducer unit, which, in turn, can be, for example, a piezoelectric drive or an electromagnetic drive. The mechanically oscillatable unit can in the case of flow measuring devices, however, also be embodied as an oscillatable tube, which is flowed through by the medium, such as, for example, in the case of a measuring device working according to the Coriolis principle.

Corresponding field devices are manufactured by the applicant in great variety and sold in the case of fill-level measuring devices, for example, under the marks, LIQUIPHANT and SOLIPHANT. The underpinning measuring principles are known, in principle, from a large number of publications. The driving/receiving unit excites the mechanically oscillatable unit by means of an electrical excitation signal, such that it executes mechanical oscillations. Conversely, the driving/receiving unit can receive the mechanical oscillations of the mechanically oscillatable unit and convert them into an electrical, received signal. The driving/receiving unit is, correspondingly, either a separate driving unit and a separate receiving unit, or a combined driving/receiving unit.

In such case, the driving/receiving unit is often part of a fed back, electrical, oscillatory circuit, by means of which the exciting of the mechanically oscillatable unit occurs, such that it executes mechanical oscillations. For example, for a resonant oscillation, the oscillatory circuit condition must be fulfilled, according to which the amplification factor is and all phases arising in the oscillatory circuit add to a multiple of 360°.

For exciting and fulfilling the oscillatory circuit condition, a certain phase shift between the excitation signal and the received signal must be assured. Therefore, frequently a predeterminable value for the phase shift, thus, a desired value for the phase shift, is set between the excitation signal and the received signal. Known for this from the state of the art are the most varied of solutions, including both analog as well as also digital methods. In principle, the setting of the phase shift can be accomplished, for example, by use of a suitable filter, or the phase shift can be controlled by means of a control loop to a predeterminable phase shift, the desired value. Known from DE102006034105A1, for example, is use of an adjustable phase shifter. The additional integration an amplifier with adjustable amplification factor for additional control of the oscillation amplitude was described, in contrast, in DE102007013557A1. DE102005015547A1 provides the application of an allpass filter. The setting of the phase shift is possible, moreover, by means of a so-called frequency sweep, such as disclosed, for example, in DE102009026685A1, DE102009028022A1, and DE102010030982A1. The phase shift can, however, also be controlled by means of a phase control loop (phase locked loop, PLL) to a predeterminable value. Such an excitation method is subject matter of DE00102010030982A1.

Both the excitation signal as well as also the received signal are characterized by frequency w, amplitude A and/or phase ϕ. Correspondingly, changes in these variables are usually taken into consideration for determining the particular process variable, such as, for example, a predetermined fill level of a medium in a container, or even the density and/or viscosity of a medium or the flow of a medium through a pipe. In the case of a vibronic limit level switch for liquids, it is, for example, distinguished, whether the oscillatable unit is covered by the liquid or freely oscillating. These two conditions, the free condition and the covered condition, are, in such case, distinguished, for example, based on different resonance frequencies, thus, by a frequency shift. The density and/or viscosity, in turn, can be ascertained with such a measurement device only when the oscillatable unit is covered by the medium.

As described, for example, in DE10050299A1, the viscosity of a medium can be determined by means of a vibronic sensor based on the frequency-phase curve (ϕ=g(ω)). This procedure is based on the dependence of the damping of the oscillatable unit on the viscosity of the medium. In such case, the lower viscosity, the steeper the frequency-phase curve falls. In order to eliminate the influence of the density on the measurement, the viscosity is determined based on a frequency change caused by two different values for the phase, thus, by means of a relative measurement. In this regard, either two different phase values can be set and the associated frequency change determined, or a predetermined frequency band is moved through and it is detected, when at least two predetermined phase values are achieved.

Known from DE102007043811A1, moreover, is to ascertain a change of viscosity from a change of eigenfrequency and/or resonant frequency and/or phase difference and/or to determine viscosity based on correspondedly stored dependencies of the oscillations of the oscillatable unit on the viscosity of the medium. Also in the case of this procedure, the dependence of the determining of viscosity on the density of the medium must be taken into consideration.

For determining and/or monitoring the density of a medium, known from DE10057974A1 are a method as well as an apparatus, by means of which the influence of at least one disturbing variable, for example, the viscosity, on the oscillation frequency of the mechanically oscillatable unit can be ascertained and correspondingly compensated. In DE102006033819A1, it is, furthermore, described to set a predeterminable phase shift between the excitation signal and the received signal, in the case of which effects of changes of the viscosity of the medium on the mechanical oscillations of the mechanically oscillatable unit are negligible. In such case, the density is essentially determined using the formula

$${ρ}_{Med} = \frac{1}{S} [ ( \frac{{F}_{0 , Vak} + C \cdot t + A \cdot {t}^{2}}{{F}_{t , p , Med}} ) \cdot ( 1 + D \cdot p ) - 1 ] ,$$

wherein S is the density sensitivity of the mechanically oscillatable unit, F_{0,vak} the frequency of the mechanical oscillations in vacuum at 0° C., C and A, respectively, the linear and square temperature coefficients of the oscillation frequency F_{0,vak} of the mechanically oscillatable unit, t the process temperature, F_{t,p,Med} the oscillation frequency of the mechanically oscillatable unit in the medium, D the pressure coefficient, and p the pressure of the medium.

In order to be independent of empirical assumptions, known from DE102015102834A1 is an analytical measuring principle for determining the density and/or viscosity by means of a vibronic sensor, which based on a mathematical model takes into consideration interactions between the oscillatable unit and the medium. The sensor is operated at two or more different predeterminable phase shifts and the process variables, density and/or viscosity, are ascertained from the response signal.

In order to assure reliable operation of a vibronic sensor, known from the state of the art are various methods, by means of which information concerning condition of the vibronic sensor can be gained. Known from DE102005, for example, is an opportunity for monitoring the quality of a vibronic sensor. A measuring apparatus includes a power measuring unit, which monitors the energy requirement of the exciter/receiving unit at least for the case of resonant oscillations. In this way, information can be gained concerning quality of the vibronic sensor. The higher the quality, the less energy is required for exciting resonant oscillations. If thus, the energy requirement for exciting resonant oscillations rises during a predeterminable period of time, or exceeds the quality of a predeterminable limit value ascertained during the manufacture of the sensor, then the presence of a defect, accretion in the region of the oscillatable unit or the like can be assumed.

Known from DE102007008669A1, in turn, is a vibronic sensor with an electronics unit, which comprises a phase measuring unit, an adjustable phase shifter and a phase matching unit, which controls the setting of the phase shift between excitation signal and received signal. Control parameters can be updated and stored in predeterminable time intervals over the duration of operation of the sensor. Furthermore, based on a comparison between stored control parameters and current control data a monitoring of the condition can be performed.

The described solutions are always adapted for a special case and particular statements. Either separate measuring devices or specially adapted electronics unit are required for monitoring condition. Desireable would be a universal monitoring function for checking a vibronic sensor.

An object of the present invention, therefore, is to provide a method for monitoring condition of a vibronic sensor, which method is easy to perform and universally applicable for different vibronic sensors.

The object is achieved according to the invention by a method for monitoring condition of a vibronic sensor, which serves for determining and/or monitoring at least one process variable of a medium in a container and which includes at least one sensor unit having a mechanically oscillatable unit, comprising method steps as follows:
ascertaining a measured value for at least one physical and/or chemical variable characteristic for the vibronic sensor, while the sensor is located at/in its location of use,
comparing the measured value of the physical and/or chemical variable with a reference value for the variable, and
ascertaining a condition indicator from the comparison.

The vibronic sensor is basically characterized by various physical or chemical variables, especially characteristic variables. Examples include the resonant frequency of the oscillatable unit, and the amplitude of the oscillations when the sensor is not in contact with a medium. These variables can be ascertained in the installed state of the sensor during ongoing operation. Additionally, reference values can be given for the particular sensor for each of the considered, characteristic, physical or chemical variables, reference values, which correspond, for example, to desired values. The desired values are values, which the particular physical or chemical variables assume, when the sensor is fully functional.

The execution of a monitoring of condition according to the invention is especially advantageous, because, for the monitoring, the particular process, for which the sensor is applied, does not need to be interrupted. The monitoring of condition can, rather, be performed at any time, without having to deinstall the sensor from the process, in order to perform the monitoring of condition. Depending on which characteristic variable is being considered, for example, points in time can be selected therefor, times when the sensor is safely not in contact with the measured medium.

Furthermore, the measured characteristic physical and/or chemical variable can be registered as a function of time. Based on this, then not only a spotwise monitoring of condition can be performed. Rather, time developments can be observed.

The method of the invention advantageously enables, furthermore, the execution of a predictive maintenance. Based on a certain measured value for the characteristic variable, it can, for example, then be estimated, when a maintenance of the sensor is required.

In an embodiment of the method, a deviation between the measured value and the reference value is determined, and the condition indicator ascertained based on the deviation. For example, a statement concerning condition of the sensor can be generated, when the deviation between the measured value and reference value exceeds a predeterminable limit value.

In an additional embodiment of the method, the at least one reference value is a value, especially a measured value, of the physical and/or chemical variable corresponding to the delivered condition of the sensor. During the manufacture of the sensor, different physical and/or chemical characteristic variables characteristic for the sensor are ascertained, or measured. Since these are taken into consideration as reference values, differences in the characteristic physical and/or chemical variables resulting from usual manufacturing tolerances can be directly taken into consideration. A time rate of change of these values then permits a statement concerning condition of the sensor.

Advantageously, the at least one reference value and/or the at least one associated measured value for the physical and/or chemical variable is/are recorded in a data sheet. The reference parameters can then, for example, be delivered to customers together with the sensor. Alternatively, a data sheet for a sensor can be requested at any time, in order to perform a monitoring of the condition. The data sheet contains preferably not only the reference values, but also limit values for the allowable deviations of measured values from the reference values.

If, likewise, the measured values for physical and/or chemical variables are registered, such can further be done as a function of time, especially over the entire duration of operation of the vibronic sensor. Thus, also very slowly arising changes of a certain physical or chemical variable can reliably be detected. Such is especially advantageous for monitoring condition as regards aging effects of a sensor.

The data sheet can contain, for example, data in tabular form. Especially, the data sheet can also be in the form of a computer readable file.

Alternatively, it is likewise advantageous that the at least one reference value and/or the at least one associated measured value for the physical and/or chemical variable be stored in an Internet based file or database. In this way, the reference value does not have to be delivered with the sensor. Rather, the reference value can be downloaded, when required. An Internet based storage is also advantageous relative to the measured values for characteristic physical and/or chemical variables. The stored data can likewise be downloaded at the factory and evaluated for improving future generations of sensors.

An embodiment of the method includes that the comparison of the measured value with the reference value is performed at the site of the process. Such is possible, for example, when the electronics unit includes a suitable comparison algorithm. The electronics unit can be correspondingly embodied from the start. Alternatively, it is, however, likewise an option that an existing electronics unit of an existing sensor be retrofitted or updated.

Another embodiment of the method includes that the at least one characteristic physical and/or chemical variable is a frequency, especially a resonant frequency, an amplitude, a phase difference between an excitation signal and a received signal, or a voltage, especially a voltage characteristic for the sensor, for example, a switching voltage.

Finally, it is advantageous that the oscillatable unit be a membrane, a single tine or an oscillatory fork.

An especially preferred embodiment includes that as condition indicator a statement concerning occurrence of accretion, corrosion, abrasion, or a cable break, or concerning penetration of moisture into at least one component of the sensor is generated and/or output. Accretion, corrosion and/or abrasion concern especially the oscillatable unit, while a cable break or the penetration of moisture can be problematic especially for the electronics unit.

Another especially preferred embodiment of the method includes, finally, that the at least one characteristic physical and/or chemical variable is a resonant frequency of the sensor. In the case, in which the measured value is greater than the reference value, then, as condition indicator, a statement is output concerning corrosion or abrasion in the region of the oscillatable unit, concerning abrasion of a coating of the oscillatable unit, concerning a defect of the oscillatable unit, or concerning presence of accretion on the oscillatable unit. In contrast, when the measured value is less than the reference value, generated and/or output as condition indicator is a statement concerning corrosion or abrasion in the region of the oscillatable unit and/or of a driving/receiving unit of the vibronic sensor, or concerning diffusion of a medium into a coating of the oscillatable unit.

The invention as well as its advantages will now be more exactly described based on the appended drawing, the figures of which show as follows:

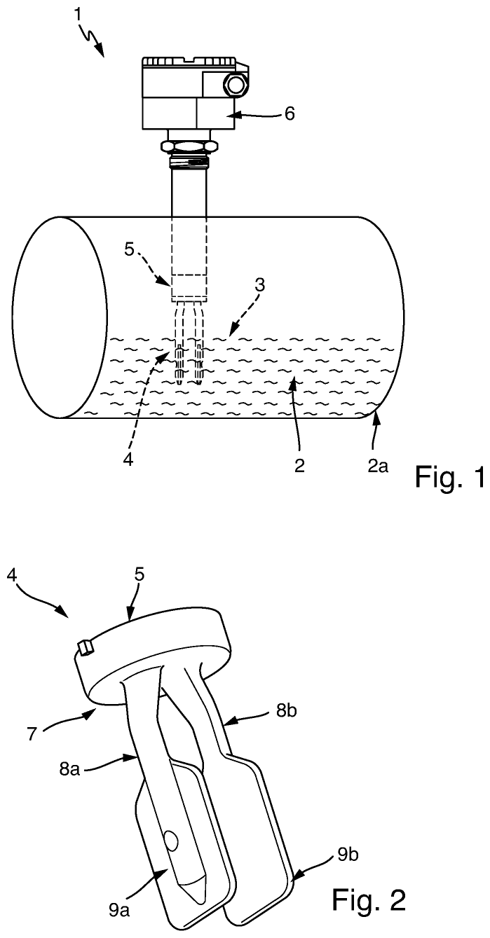

FIG. 1 a vibronic sensor of the state of the art; and

FIG. 2 an oscillatable unit of a vibronic sensor, wherein the oscillatable unit is in the form of an oscillatory fork.

FIG. 1 shows a vibronic sensor 1. Shown is a sensor unit 3 with an oscillatable unit 4 in the form of an oscillatory fork, which is partially immersed in a medium 2, which is located in a container 2a. The oscillatable unit 4 is excited by means of the exciter/receiving unit 5, such that it executes mechanical oscillations. The exciter/receiving unit 5 can be, for example, a piezoelectric stack- or bimorph drive. Of course, also other embodiments of a vibronic sensor fall within the scope of the invention. Additionally shown is an electronics unit 6, by means of which signal registration, —evaluation and/or—feeding occurs.

FIG. 2 shows in a side view an oscillatable unit 4 in the form of an oscillatory fork, such as, for example, an oscillatory fork as integrated in the vibronic sensor 1 sold by the applicant under the mark, LIQUIPHANT. The oscillatory fork 4 includes two oscillatory tines 8a,8b formed on a membrane 7 and bearing two terminally located paddles 9a,9b. The oscillatory tines 8a,8b together with the paddles 9a,9b are frequently also referred to together as fork tines. In order to cause the mechanically oscillatable unit 4 to execute mechanical oscillations, a driving/receiving unit 5 mounted by material bonding on the side of the membrane 7 far from the oscillatory tines 8a,8b exerts a force on the membrane 8. The driving/receiving unit 5 is an electromechanical transducer unit, and comprises, for example, a piezoelectric element, or even an electromagnetic drive [not shown]. The driving/receiving unit 5 can be two separate units, or one combined driving/receiving unit. In the case, in which the driving/receiving unit 5 comprises a piezoelectric element 9, the force exerted on the membrane 7 is generated by applying an excitation signal U_{E}, for example, in the form of an electrical, alternating voltage. A change of the applied electrical voltage effects a change of the geometric shape of the driving/receiving unit 5, thus, a contraction, or a relaxation, within the piezoelectric element in such a manner that the applying of an electrical, alternating voltage as excitation signal U_{E} brings about an oscillation of the membrane 7 connected by material bonding with the driving/receiving unit 5. Conversely, the mechanical oscillations of the oscillatable unit are transmitted via the membrane to the driving/receiving unit 5 and converted into an electrical, received signal U_{R}. The particular process variable, for example, a predeterminable fill level of medium 2 in the container 2a, or even the density or viscosity of the medium 2, can then be ascertained based on the received signal U_{R}.

An opportunity for monitoring the condition of the vibronic sensor will now be explained based on a comparison of a measured frequency f of the oscillatable unit 4, especially the resonant frequency f₀ of the sensor 1,with a corresponding reference value for the frequency f_{ref}, f_{0,ref}. Of course, a monitoring of the condition can, however, also be performed based on any other physical and/or chemical variable characteristic for the vibronic sensor 1, for example, the amplitude A, the phase difference ϕ between the excitation signal U_{E} and the received signal U_{R}, or a voltage, especially a voltage characteristic for the sensor, for example, a switching voltage..

A measured value for the resonant frequency f₀ of the vibronic sensor 1 can be ascertained from the received signal U_{R}. In given cases, other, different process parameters are taken into consideration for executing a comparison of the measured value f₀ with a reference value f_{0,ref} for the frequency, in order based on the comparison to be able to obtain an exact statement concerning condition of the sensor 1. These process parameters can include, for example, the temperature T or the pressure p, or even the covered condition of the oscillatable unit 4.

Ideally, the process conditions existing at the time when the measured value for the frequency f₀ was taken are the same as the process conditions existing when the reference value f_{0,ref} was determined.

The frequency f₀ the oscillatable unit 4 is, for example, temperature- and pressure dependent. Usually, the reference values, in this case, thus, the reference value for the resonant frequency f_{0,ref} of the oscillatable unit 4, are determined essentially at standard conditions, thus, at room temperature and standard pressure. Correspondingly, it is helpful when the temperature T in the process at the time of measurement of the frequency f₀ lies in a range of about 20-30° C. and there reigns in the process neither a positive pressure nor a negative pressure. Alternatively, for example, characteristic lines, curves or compensation functions relative to the dependence of individual characteristic variables, such as, for example, the frequency f₀, on particular process conditions, such as the temperature T or the pressure p, can be used, in order to convert the measured values suitably.

Moreover, the resonant frequency for the case, in which the oscillatable unit 4 is not in contact with a medium, is determined, so that such requirement for monitoring the condition is ideally likewise fulfilled as regards the frequency f₀.

Based on comparison of the measured value for the frequency f₀ with the respective reference value f_{0,ref}, then a statement concerning condition can be generated. For example, a predeterminable limit value can be defined. If the deviation exceeds this limit value, then, in given cases, a problem exists, or the sensor needs to be serviced. The method of the invention offers, thus, the opportunity for predictive maintenance. For example, it can be noted that maintenance of the sensor or even a cleaning cycle for the oscillatable unit is due, for example, in the case, in which accretion has formed in the region of the oscillatable unit. Moreover, the measured value for the frequency f₀ can be plotted as a function of time and, for example, based on the curve, an estimate made for when such a maintenance and/or cleaning should be performed.

In the case of a rise of the resonant frequency f₀ above the predeterminable limit value, for example, especially symmetrically distributed, accretion or corrosion can be present in the region of the oscillatable unit 4. It is also possible that abrasion or a coating has occurred in the region of the oscillatable unit 4, or also that the oscillatable unit is defective, for example, broken. In the case of a decrease of the resonant frequency f₀ below a predeterminable limit value, on the other hand, corrosion or abrasion can be present in the region of the oscillatable unit and/or of a driving/receiving unit of the vibronic sensor, or a diffusion of a medium into a coating of the oscillatable unit has occurred.

1-10. (canceled)

11. A method for monitoring a condition of a vibronic sensor, which serves for determining and/or monitoring at least one process variable of a medium in a container and includes at least one sensor unit having a mechanically oscillatable unit, the method including steps of:
ascertaining a measured value for at least one physical and/or chemical variable characteristic for the vibronic sensor, while the vibronic sensor is located at/in its location of use;
comparing the measured value for the physical and/or chemical variable characteristic with a reference value for the physical and/or chemical variable characteristic; and ascertaining a condition indicator from the comparison.

12. The method of claim 11, wherein a deviation between the measured value and the reference value is determined, and wherein the condition indicator is ascertained based on the deviation.

13. The method of claim 11, wherein the reference value is a value of the physical and/or chemical variable characteristic corresponding to a delivered condition of the vibronic sensor.

14. The method of claim 11, wherein the reference value and/or the associated measured value for the physical and/or chemical variable characteristic is/are recorded in a data sheet.

15. The method of claim 11, wherein the reference value and/or the associated measured value for the physical and/or chemical variable characteristic are/is stored in an Internet based file or database.

16. The method of claim 11, wherein the comparison of the measured value with the reference value is performed at a process site.

17. The method of claim 11, wherein the physical and/or chemical variable characteristic is a frequency, an amplitude, a phase difference between an excitation signal and a received signal, or a voltage.

18. The method of claim 11, wherein the mechanically oscillatable unit is a membrane, a single tine or an oscillatory fork.

19. The method of claim 11, wherein, according to the condition indicator, a statement concerning occurrence of accretion, corrosion, abrasion, or a cable break, or concerning penetration of moisture into at least one component of the vibronic sensor is generated and/or output.

20. The method of claim 11, wherein the physical and/or chemical variable characteristic is a resonant frequency of the vibratory sensor;
wherein, when the measured value is greater than the reference value, then according to the condition indicator a statement is output concerning corrosion or abrasion in the region of the oscillatable unit, concerning abrasion of a coating of the oscillatable unit, concerning a defect of the oscillatable unit, or concerning presence of an accretion on the oscillatable unit; or
wherein, when the measured value is less than the reference value, then generated and/or output as the condition indicator is a statement concerning corrosion or abrasion in the region of the oscillatable unit and/or of a driving/receiving unit of the vibronic sensor, or concerning diffusion of a medium into a coating of the oscillatable unit.
